(19) United States
(12) Patent Application Publication
(10) Pub. No.: US 2009/0106436 A1
(43) Pub. Date: Apr. 23, 2009

(54) METHODS AND SYSTEMS FOR OFFLOAD PROCESSING

(75) Inventors: Per Andersson, Montreal (CA); Bartosz Balazinski, Montreal (CA); Jon Maloy, Montreal-Nord (CA)

Correspondence Address: ERICSSON INC., 6300 LEGACY DRIVE, M/S EVR 1-C-11, PLANO, TX, 75024, US

(73) Assignee: TELEFONAKTIEBOLAGET LM ERICSSON (PUBL), Stockholm (SE)

(21) Appl. No.: 11/877,254

(22) Filed: Oct. 23, 2007

(51) Int. Cl. G06F 15/16

(52) U.S. Cl. 709/230

(57) ABSTRACT

Communication nodes, systems and methods are described which provide offload processing capabilities. Tasks can be offloaded from a host element to an offload processing element. Incoming data streams can have their associated Layer 3/Layer transportation protocol stacks terminated. Data can be repackaged and routed using an internal, offload protocol which also preserves L3 and/or L4 information.

### TECHNICAL FIELD

The present invention generally relates to data processing systems and methods and, more particularly, to mechanisms and techniques for offloading processing from a host element to an offload processing element.

### BACKGROUND

At its inception cellular phone technology was designed and used for voice communications only. As the consumer electronics industry continued to mature, and the capabilities of processors increased, more devices became available for public use that allowed the transfer of data between devices and more applications became available that operated based on their transferred data. Of particular note are the Internet and local area networks (LANs). These two innovations allowed multiple users and multiple devices to communicate and exchange data between different devices and device types. With the advent of these devices and capabilities, users (both business and residential) found the need to transmit data, as well as voice, from mobile locations.

Today, some mobile and fixed communications network architectures are in the process of merging. Internet Protocol (IP) is seen as becoming the network protocol of choice for many of these evolving, next generation, communication networks. These systems will likely include a number of different nodes associated with the network architecture for handling data and voice communications. Such nodes will have different names given to them by, for example, the various standardization groups to designate their respective functions within the network. Some current examples of such network nodes which are associated with various mobile networks (and various standards) include a Gateway GPRS Support Node (GGSN) which operates as a gateway between a GPRS data network and other networks, a Serving GPRS Support Node (SGSN) which operates to deliver data packets within a geographical service area, a Packet Data Serving Node (PDSN) which manages point-to-point protocol (PPP) sessions between a core IP network and a mobile station.

These types of communication nodes can be implemented as servers which consist of systems built around one or several tightly coupled control processors for performing control plane (also referred to as “slow path”) processing, and several payload processors for processing the user traffic (also referred to as the “fast path”). These cluster type nodes or systems are likely to evolve into systems wherein all of the processing components are interconnected through a high performance Ethernet backplane and include off-the-shelf (OTS), high performance, task specific processors.

These OTS processors have the capability to perform specialized tasks very efficiently. On the other hand they typically lack any general purpose processing capabilities. For example, some communications nodes include OTS task specific processors that are designed to perform Layer 2 (L2) functions, e.g., functions associated with Ethernet or Point-to-Point Protocol (PPP) data transfer and error correction. In such L2 processor clusters, it is very inefficient to have these specialized processors implement any Layer 3 (L3) or higher communication protocols for interconnection between components of the system. Therefore, proprietary solutions are typically utilized in order to achieve interconnection between these components and the rest of the system. This renders the system components tightly coupled and the overall system architecture lacks flexibility.

Accordingly, it would be desirable to have systems and methods for offload processing which avoids the afore-described problems and drawbacks.

### SUMMARY

According to one exemplary embodiment, an offload processing node includes an offload element for terminating higher layer communications protocols associated with data incoming to the offload processing node, repackaging the data into message flow packets using an offload protocol and forwarding the message flow packets toward one of an offload processing element and a host element, wherein the offload processing element processes said message flow packets directed thereto to perform tasks offloaded from the host element, and the host element processes the message flow packets directed thereto.

According to another exemplary embodiment, a method for offloading data processing tasks from a host element to an offload processing element includes terminating higher layer communications protocols associated with incoming data, repackaging the data into message flow packets using an offload protocol, forwarding the message flow packets toward one of an offload processing element and a host element, processing, by the offload processing element, the message flow packets directed thereto to perform tasks offloaded from the host element, and processing, by the host element, the message flow packets directed thereto.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 illustrates an offload processing node according to an exemplary embodiment;

FIGS. 2(a)-2(c) illustrate various methods and data flows for performing offload processing according to exemplary embodiments;

FIG. 3 illustrates an exemplary message format for an internal message flow according to an exemplary embodiment;

FIG. 4 depicts an offload processing element and a host element according to an exemplary embodiment; and

FIG. 5 is a flowchart illustrating a method for offload processing according to an exemplary embodiment.

### DETAILED DESCRIPTION

The following description of the exemplary embodiments of the present invention refers to the accompanying drawings. The same reference numbers in different drawings identify the same or similar elements. The following detailed description does not limit the invention. Instead, the scope of the invention is defined by the appended claims.

According to exemplary embodiments, the capabilities of the L2 cluster aspect of emerging nodes or systems is capitalized upon while also utilizing dedicated processors in order to perform selected tasks efficiently. For example, this may be achieved in a system where L3 and above transportation protocols are terminated at an entry point (interface) to the communication node, and the different application layers are processed by distributed components, e.g., arranged into a pipeline. Since the higher layer protocols are terminated at the interface point, these node components can be interconnected with an offload (L2-like) transportation and control protocol. The offload protocol enables higher layers (L3/L4) to be terminated, but preserves some of the L3/L4 information to be used in processing the flow. More specifically, each processing request becomes a flow within the node, which flow is passed through the elements of the pipeline via the offload transportation and control protocol.

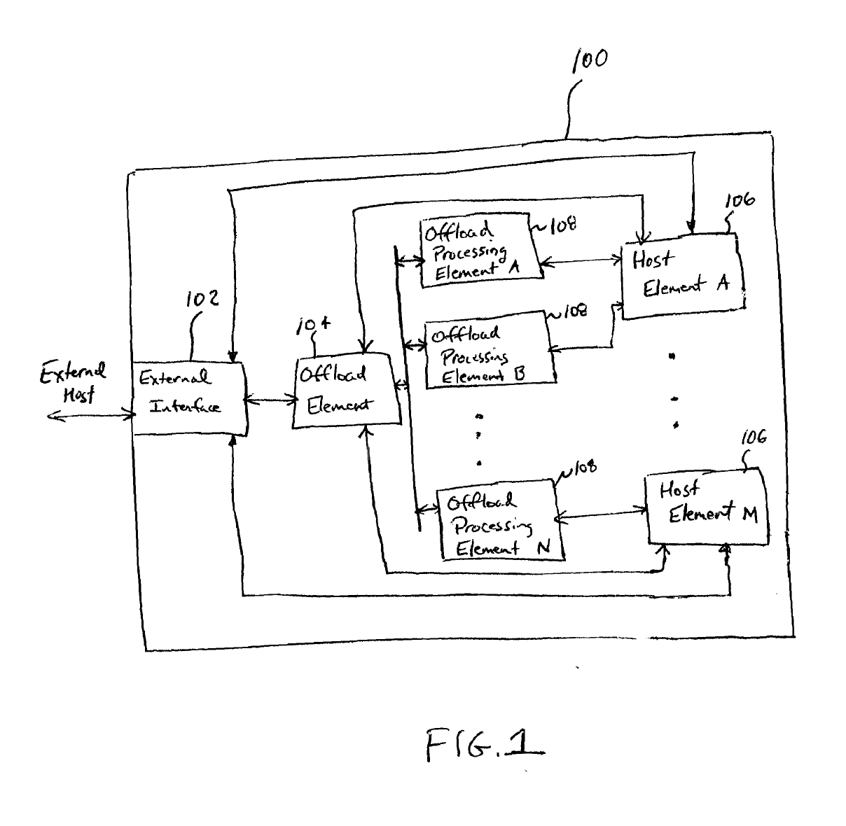

FIG. 1 depicts such an offload system or communications node 100 according to an exemplary embodiment, wherein the processing of incoming requests is distributed over several internal elements based upon, for example, the transportation protocol layers involved. Therein, data is received from, and transmitted to, for example, an external host (not shown) by an external interface element 102. Although only one external interface element 102 is shown in FIG. 1, it will be understood that the exemplary offload system 100 may include more than one external interface element 102, which can, for example, be a router or switch port capable of sending and receiving IP packets. Additionally, external interface element 102 can be included as part of the offload system or node 100 or may be disposed external thereto.

Data received from external interface 102 is forwarded to offload element 104. Although only one offload element 104 is shown in FIG. 1, it will be appreciated that the exemplary offload system 100 may include more than one offload element 104. According to this exemplary embodiment, the offload element 104 acts as the L3 termination for all of the traffic addressed to the node 100. As described in more detail below, this termination process involves, e.g., dividing L3 packets and L4 streams into smaller data portions which are re-packaged using, for example, an exemplary offload protocol described below. The Layer 4 (L4) session termination may be set up by the host element(s) 106 through a configuration process. In addition to terminating the L3 layer, the offload element 104 is responsible for either forwarding the received data packets directly to the host (processing) element(s) 106 or sending the data packets to an intermediate offload processing element 108.

The offload processing elements 108 are designed to perform specific task(s) in order to offload that task from the host (processing) elements 106, including dedicated hardware and software. Some purely illustrative examples of tasks which can be offloaded from host elements 106 (e.g., which are designed to handle L2 processing) include, but are not limited to, message framing (e.g., SOAP or SIP framing), message conversion/decompression, message transformation, message encryption/decryption and message load sharing. Several offload processing elements have been shown in the exemplary embodiment of FIG. 1, however it will be appreciated that more or fewer may be present in any given implementation. Additionally, the offload processing element(s) 108 may be co-located with the offload element(s) 104. Since the L3 and L4 transport protocol layers have been terminated in the offload element 104, the offload processing elements 108 need only support the protocol stack up to L2.

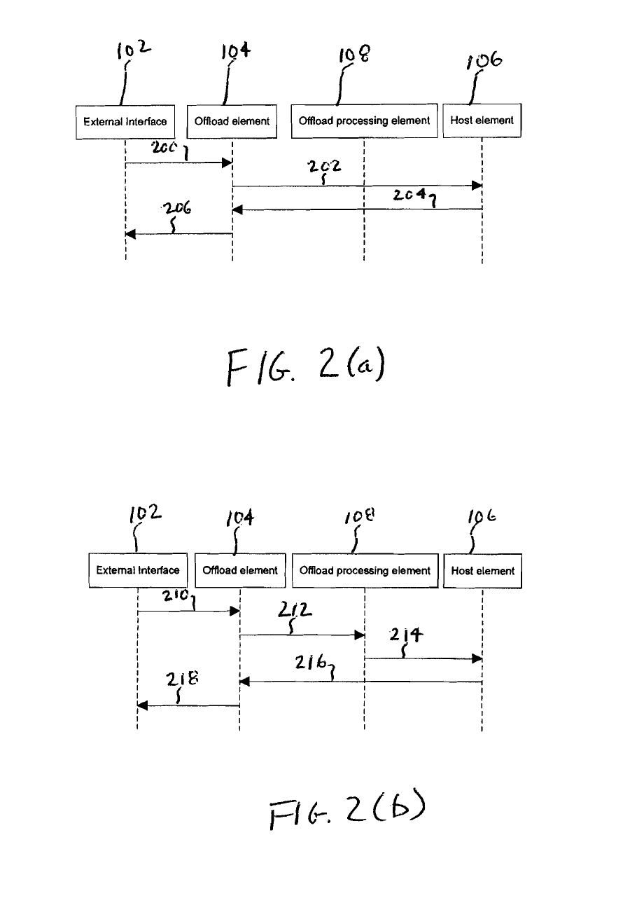

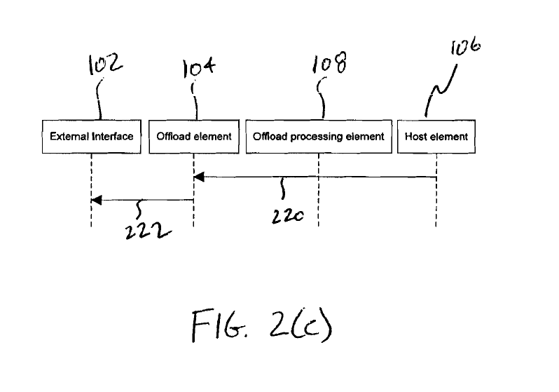

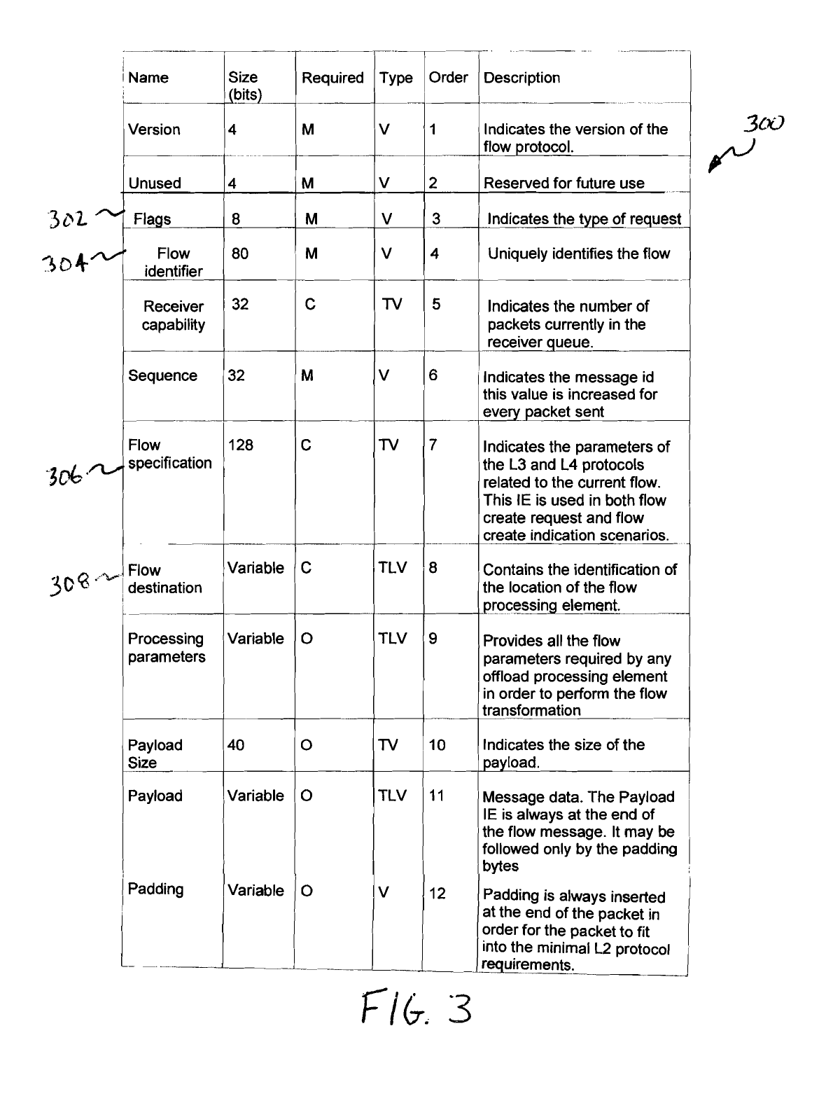

Having briefly described a general architecture associated with offload systems and communication nodes according to these exemplary embodiments, some methods for using such architectures will now be described to provide some context, followed by a more detailed discussion of the L3/L4 termination which occurs at the offload element 104 and the resulting data flows which are routed through the offload systems. The flow diagram provided as FIG. 2(a) depicts an exemplary method for handling pass-through data, i.e., data which is not transformed into the local offload protocol or handled by an offload processing element 108, but which is instead routed directly from the offload element 104 to a host (processing) element 106. Therein, at step 200, a packet is received at the offload element 104 having an IP address which corresponds to the L3 termination associated with the offload system 100 and/or one of its associated host element(s) 106.

The offload element 104 can identify the arriving packet as being either a pass-through packet, i.e., a packet which will be passed directly on to one of its associated host element(s) 106, or an offload packet, i.e., a packet which is to be directed toward an offload processing element 108, in one of a variety of different ways. For example, the offload element 104 can perform this classification based upon the port on which the packet or message arrives or is associated with. As a purely illustrative example, suppose that all messages arriving on a connection created from port NN are known to be of protocol Y, (e.g. port 5060 for SIP messages), and are therefore routed toward an offload processing element 108, while messages on all other connections and ports are considered to be pass-through packets. The specific manner in which packets are characterized as pass-through or offload by the offload element 104 will vary by implementation and, therefore, can be implemented as a configurable policy, determined by a control function.

Next, at step 202, the source Medium Access Control (MAC) address is replaced with the offload element 104's own MAC address and the destination MAC address is replaced by the MAC address of the host element 106 to which the packet is to be forwarded. After receiving the forwarded IP packet, the host element 106 sends an acknowledgement at step 204 to the offload element 104 which forwarded the packet. This acknowledgement is then routed as a packet through the external interface 102.

If, on the other hand, the IP packet received by the offload element 104 is associated with a task which is to be offloaded from the host (processing) element 106, then a method associated with L3/L4 termination and creation of an internal data flow is performed, an example of which is illustrated as FIG. 2(b). Therein, at step 210, an IP packet is again received by the offload element 104, which packet corresponds to a registered L3/L4 interception, i.e., a packet which is to be routed to an offload processing element 108 instead of a host processing element 106. Techniques associated with registering certain packets for L3/L4 interception versus handling as pass-through data are described in more detail below.

Assume, for this example, that the received IP packet is the first packet in a stream associated with a task that has been designated for offloading from the host element(s) 106, e.g., message decompression. At step 212, the offload element 104 creates and forwards a new (internal) data flow toward the corresponding offload processing element 108, e.g., a specialized processor with specialized software dedicated to the type of message decompression associated with this data stream being forwarded to the offload system 100 by an external host. More specifically, the offload element 104 strips off all L3 and L4 headers from the received IP data packet and creates a new flow packet which includes, for example, the following information: a new flow identifier, a sequence number which is unique to this packet within this flow (e.g., starting with number 0), L3/L4 termination information, payload data and processing parameters which enable the offload processing element 108 which receives the flow packet to process its payload. A detailed example of a flow packet format, including these and other information elements, is provided below with respect to FIG. 3.

As part of the reformatting process performed in step 212, the offload element 104 also adds the L2 destination MAC address of the offload processing element 108 to the new flow packet and then forwards the flow packet toward that offload processing element 108. The offload processing element 108, at step 214, processes the payload of the flow packet and forwards the flow packet with a new payload containing the outcome of its specialized processing towards a host processing element 106. According to one exemplary embodiment, the information elements in the flow packet forwarded to the host element 106 (other than the payload) are unchanged relative to their values as received by the offload processing element 108.

After processing the payload in the flow packet, the host processing element 106 builds a flow message including, for example, a set delete flag, a set end-of-packet flag, the same flow identification received by the host element 106 from the offload processing element in step 214, a sequence number set to zero, a payload size information element set to the size of the payload contained in the flow message, and a response message provided in the payload information element. Examples of these and other information elements which can be included in flow messages according to exemplary embodiments are provided in the exemplary offload protocol described below. This flow message is then forwarded toward the offload element 140 as shown in step 216. Upon receiving the response message, the offload element 104 associates the response message with the existing flow. The payload is forwarded on the corresponding L3/L4 connection via the external interface 102 (step 218) and the flow internal to the offload system 100 is then destroyed.

The discussion above with respect to FIG. 2(b) illustrates an exemplary method for handling incoming data packets according to an exemplary embodiment. FIG. 2(c) illustrates a flow in the reverse direction beginning with the host element 106. Therein, at step 220, the host element 106 builds a request (or a response) to an external host by creating a flow message. According to one exemplary embodiment, the flow message can include a set create flag, a set delete flag, a set end-of-packet flag, a flow specification information element which contains the destination IP address and port of the external host to which the flow message is directed, a new flow identification, a sequence number set to zero, a payload size information element set to the size of the payload contained in the flow message, and a request (or response) message provided in the payload information element. A detailed example of a format of such a flow message is described below with respect to FIG. 3.

The flow message is received by the offload element 104, which in turn creates a new flow based on the flow specification information element contained therein. A new connection is established with the address and port specified in the flow specification information element (step 222). The payload contained in the flow message is forwarded using the newly created connection and, once the message has been forwarded, the node internal flow is deleted. Having described an exemplary offload system 100 and several exemplary use cases (FIGS. 2(a)-2(c)), a detailed (but purely illustrative) example of a flow message format 300 which can be used as part of the internal, offload protocol to pass data between, e.g., elements 104, 106 and 108, will now be described with respect to FIG. 3. It will be appreciated, however, that the foregoing exemplary embodiments can be used with flow message formats other than that described below.

Therein, the exemplary flow message format 300 includes twelve fields or information elements. Starting from the lefthand side, the first column in the format 300 provides a name for the information element, the second column indicates an exemplary size of the field (number of bits), and the third column denotes whether the presence of each information element is “mandatory” (M), “conditional” (C), or “optional” (O) in any given flow packet. The fourth column provides a type for the information element. In this exemplary embodiment, each information element may either be of the type value alone (V), type followed by value (TV) or type followed by information element length and value (TLV). The information element types TV and TLV identify information elements (IEs) having the characteristics identified in Tables 1 and 2 below, respectively. The information element type V is used simply to identify those ILEs which are not of type TV or TLV.

TABLE 1
TV IE format

| | Size | |
|---|---|---|
| Field Name | (bits) | Description |
| Type | 8 | Contains the identification of the current IE |
| Data | V | The IE value, each TV IE has its own fixed size |

TABLE 2
TLV IE format

| | Size | |
|---|---|---|
| Field Name | (bits) | Description |
| Type | 8 | Contains the identification of the current IE |
| Length | 16 | Indicates the size of the IE in bytes |
| Data | V | The IE value, each TLV IE has its own size |

The fifth column identifies an order in which each information element is found (if present) within a flow message packet 300. The righthand most column provides a short description of the function of each information element. A further description of some of these information elements which were referred to above in the description of FIGS. 2(a)-2(c) will now be provided. For example, as described above, in certain situations it is useful to enable the flow creator, e.g., an offload element 104 or host element 106, to identify the request type associated with a given flow message packet 300. This can be accomplished by setting the flags IE 302 to, for example, one of the values shown below in Table 3.

TABLE 3
Flow message Flags

| Name | Value (hex) | Description |
|---|---|---|
| Create Indication | 0x01 | Indicates a new flow creation from a |
| | | preconfigured L3/L4 protocol |
| | | termination. When this flag is set the |
| | | flow specification field is present. |
| Create Request | 0x02 | Indicates a new flow creation request |
| | | as a L3/L4 client. When this flag is set |
| | | both the flow specification and the |
| | | flow destination fields are present. |
| Delete | 0x04 | Indicates that the flow has to be |
| | | destroyed after servicing all the other |
| | | requests and reaching the end of the |
| | | packet (the end of packet flag is set). |
| | | The delete flag is also used in order |
| | | to abort the processing of a flow. |
| Modify | 0x08 | Reserved for future use. |
| Accumulate | 0x10 | Accumulating payload until the end of |
| | | packet is received before processing. |
| End of packet | 0x20 | This flow message contains the last |
| | | chunk of a packet that belongs to this |
| | | flow. |

A flow message packet 300 may include more than one set action flag. If so, these can be operated on in accordance with the priority table below.

TABLE 4
Flow Action Flag Priority

| Flag name | Priority | Comments |
|---|---|---|
| Create indication | 1 | These flags are exclusive |
| Create request | | |
| Modify | | |
| Process payload | 2 | |
| Destroy | 3 | The flow destruction may only be |
| | | performed after the last payload chunk |
| | | has been processed |

As stated in FIG. 3, the flow identifier IE 304 is used to uniquely identify the internal node flow (offload protocol) to which a given flow message packet 300 is assigned. This can be accomplished by, for example, using the exemplary flow identifier structure shown in Table 5 below.

TABLE 5
Flow Identifier Structure

| | Size | |
|---|---|---|
| Field name | (bits) | Description |
| Host Id | 48 | Unique host identification, physical or logical |
| Sequence | 32 | Each flow is identified by a sequence number that is |
| number | | increased for each new flow by the host that creates |
| | | it or requests its creation. The value of “0xffffffff” |
| | | indicates that this packet is not associated to any |
| | | flow |

The flow specification IE 306 contains the parameters which characterize the (terminated) L3/L4 protocol associated with this particular flow. Examples are given in Table 6 below. The preserved L3/L4 information set forth therein is used to identify the flow and to indicate where and how to send messages which are returned by the system in conjunction therewith. For example, for incoming Session Initiation Protocol (SIP) messages or Real Time Streaming Protocol messages, this provides the capability for the host application to see the real endpoint addresses associated with incoming messages as opposed to only the data contained in such incoming SIP or RTSP messages.

TABLE 6
Flow Specification Structure

| | Size | |
|---|---|---|
| Field name | (bits) | Description |
| Routing | 16 | Identification of the routing instance that either |
| instance | | the flow has been created on or it is requested |
| | | to be created. |
| Protocol | 8 | Protocol identifier, e.g., 6 for TCP and 17 for |
| | | UDP. |
| Source IP | 32 | Source IPv4 or IPv6 address, 0 means that |
| address | | any source address may be used. |
| Destination IP | 32 | Destination IPv4 or IPv6 address, 0 means that |
| address | | any destinations address may be used. |
| Source port | 16 | Source TCP/UDP port, 0 means that any source |
| | | port may be used. |
| Destination | 16 | Destination TCP/UDP port, cannot be set to 0. |
| port | | |
| Idle Time | 8 | Maximum idle time before the flow is torn |
| | | down, 0 means infinite. |

The flow destination IE 308 contains, for example, two fields which identify the destination to which the flow associated with the flow message packet 300 is being forwarded to for further processing. As will be appreciated by those skilled in the art, the destination and source ports are typically numbers which are assigned to user sessions and server applications in, e.g., an IP network. The port number can, for example, be provided in the TCP or UDP header of a data packet. An example of a format for this IE 308 is shown below as Table 7.

TABLE 7
Flow Destination Structure

| | Size | |
|---|---|---|
| Field name | (bits) | Description |
| Destination | 8 | Indicates the type of destination identification that |
| type | | follows in the next field, only a value of 1 |
| | | identifying a MAC address flow destination is |
| | | currently supported |
| Destination | 48 | Destination element MAC address |

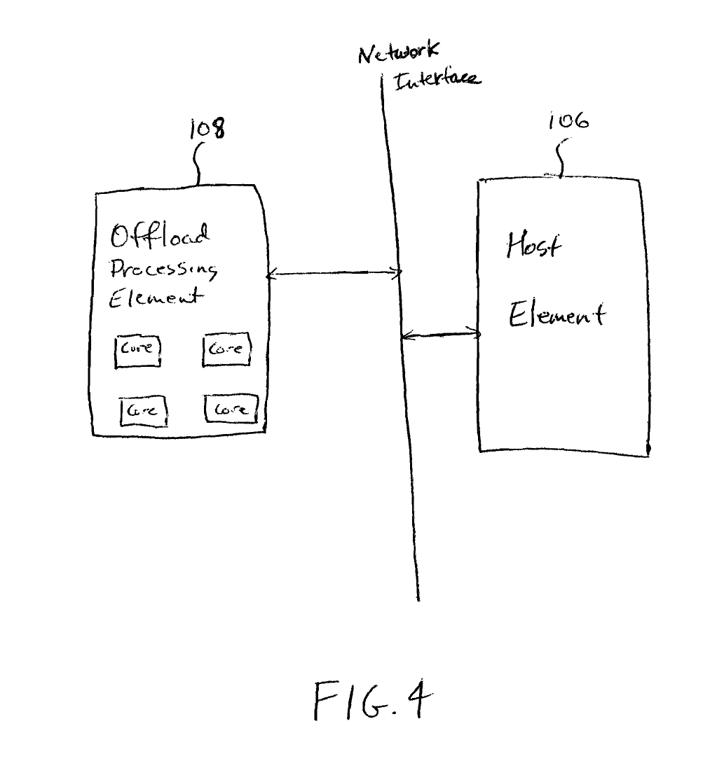

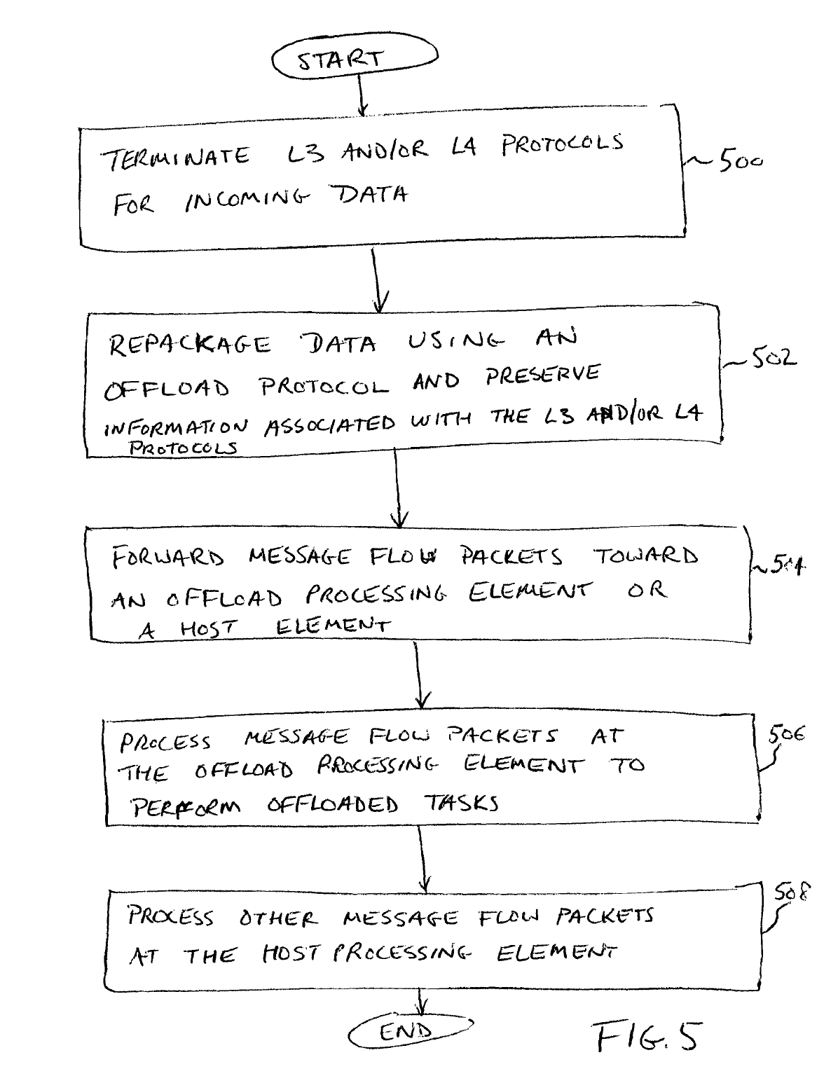

The foregoing exemplary embodiments illustrate methods and systems for enabling a processing system to offload specialized tasks from host processing elements 106 and have those specialized tasks performed by specialized hardware and/or software offload processing elements 108. These specialized hardware and/or software elements can, for example, be programmable to perform different, specialized tasks such as encryption/authentication (e.g., IP Sec), SIP message formatting and other processing and TCP processing. For example, as shown in FIG. 4, an offload processing element 104 can be implemented using a quad core processor wherein each core is programmed to perform a task offloaded from host element 106. These elements can be interconnected using, e.g., a network interface, as shown. As described above, an offload protocol is provided, e.g., using the message flow packet format 300, which preserves higher layer message information (e.g., higher layer message boundaries and information associated with higher layer processes to be performed on the message) so that this information need not be recreated by the recipient of the flow, e.g., a host element 106 or an offload processing element 108.

Thus a method for offloading data processing tasks from a host element to an offload processing element according to an exemplary embodiment can include the steps shown in the flowchart of FIG. 5. Therein, at step 500, higher layer communications protocols associated with incoming data, e.g., L3 and/or L4 are terminated. The data is repackaged, at step 502, into message flow packets using an offload protocol, while also preserving information associated with the L3 and/or L4 protocols as described above. Then, the message flow packets are forwarded toward either an offload processing element or a host element depending, e.g., upon the particular processing task associated therewith at step 504. If forwarded toward an offload processing element, then such packets are processed by the offload processing element 108 to perform tasks offloaded from the host element 106. Otherwise, processing, by the host element 106, the message flow packets directed thereto.

The foregoing description of exemplary embodiments provides illustration and description, but it is not intended to be exhaustive or to limit the invention to the precise form disclosed. Modifications and variations are possible in light of the above teachings or may be acquired from practice of the invention. For example, instead of preserving the L3/L4 information in the offload protocol as described above, the L3/L4 information could be stored within the offload element and a reference to that information passed along in the offload protocol packet, to then be found and used on the return path when a response is returned from the host element. The following claims and their equivalents define the scope of the invention.

1. An offload processing node comprising:
an offload element for terminating higher layer communications protocols associated with data incoming to said offload processing node, repackaging said data into message flow packets using an offload protocol and forwarding said message flow packets toward one of an offload processing element and a host element;
said offload processing element for processing said message flow packets directed thereto to perform tasks offloaded from said host element; and
said host element for processing said message flow packets directed thereto.

2. The offload processing node of claim 1, wherein said higher layer protocols which are terminated by said offload element include at least one of Layer 3 and Layer 4 protocols.

3. The offload processing node of claim 2, wherein information associated with said at least one of said Layer 3 and Layer 4 protocols are preserved within an information element in said message flow packets.

4. The offload processing node of claim 3, wherein said information includes at least one of: an IP type, a source IP address, a destination IP address, a higher layer protocol used to convey said data, a destination port and a source port.

5. The offload processing node of claim 1, wherein said message flow packets include an information element containing a medium access control (MAC) address associated with said one of said offloading processing element and said host element toward which said message flow packets are directed.

6. The offload processing node of claim 1, wherein each of said message flow packets include at least one flag which selectively indicate that said message flow packets are associated with either (a) a new flow creation from a preconfigured Layer 3/Layer 4 protocol termination or (b) a new flow creation request as a Layer 3/Layer 4 client.

7. The offload processing node of claim 1, further comprising:
an external interface for sending IP packets from, and receiving IP packets for, said offload node.

8. A method for offloading data processing tasks from a host element to an offload processing element comprising:
terminating higher layer communications protocols associated with incoming data;
repackaging said data into message flow packets using an offload protocol;
forwarding said message flow packets toward one of an offload processing element and a host element;
processing, by said offload processing element, said message flow packets directed thereto to perform tasks offloaded from said host element; and
processing, by said host element, said message flow packets directed thereto.

9. The offload processing method of claim 8, wherein said higher layer protocols which are terminated by said offload element include at least one of Layer 3 and Layer 4 protocols.

10. The offload processing method of claim 9, further comprising:
preserving information associated with said at least one of said Layer 3 and Layer 4 protocols within an information element in said message flow packets.

11. The offload processing method of claim 10, wherein said information includes at least one of: an IP type, a source IP address, a destination IP address, a higher layer protocol used to convey said data, a destination port and a source port.

12. The offload processing method of claim 8, wherein said message flow packets include an information element containing a medium access control (MAC) address associated with said one of said offloading processing element and said host element toward which said message flow packets are directed.

13. The offload processing method of claim 8, wherein each of said message flow packets include at least one flag which selectively indicate that said message flow packets are associated with either (a) a new flow creation from a preconfigured Layer 3/Layer 4 protocol termination or (b) a new flow creation request as a Layer 3/Layer 4 client.
